(19) United States
(12) Patent Application Publication
(10) Pub. No.: US 2012/0288843 A1
(43) Pub. Date: Nov. 15, 2012

(54) INTERACTIVE LEARNING SYSTEM AND METHOD

(75) Inventors: Alexandria V. SHAFFER, Brooklyn, NY (US); Jonathan B. SANTAMARIA, Asbury, NJ (US)

(73) Assignee: G2 COLLECTIVE, LLC, Asbury, NJ (US)

(21) Appl. No.: 13/469,722

(22) Filed: May 11, 2012

Related U.S. Application Data
(60) Provisional application No. 61/485,652, filed on May 13, 2011.

(51) Int. Cl. G09B 5/00

(52) U.S. Cl. 434/350

(57) ABSTRACT

An interactive teaching and learning system and method is presented. In one aspect, the interactive teaching and learning system is a web-based cloud application in the form of a course design, teaching, learning and communication portal.

### PRIORITY CLAIM

This application claims the benefit and priority of, U.S. Provisional Patent Application Ser. No. 61/485,652, filed on May 13, 2011, and the entire contents of such application are hereby incorporated by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### FIELD OF THE INVENTION

Presented herein is an interactive teaching and learning system and method. More specifically, a method and system for a web-based cloud application in the form of a teaching, learning, course design, data storage, reporting and communication portal is presented.

### BACKGROUND OF THE INVENTION

Effective, interactive online teaching, learning, curriculum design and administration have been cumbersome, non-intuitive and costly. There are few purely cloud based applications that are simple to use from a course design, course delivery and administrative perspective. Moreover there are even fewer e-teaching platforms that facilitate human to human interactive teaching. Current approaches are often beyond the economic, technical and administrative reach for many business and teaching institutions that lack sophisticated IT departments or sufficient funding to design and administer online interactive programs. In addition, larger, non-academic enterprises have little means of self-contained, easily editable, interactive teaching/knowledge transfer platforms which are infinitely expandable and can track and store data.

Online learning platforms are traditionally cumbersome to use from the administrative and teaching user interfaces, as well as the process delivered to the learner. While a content management system exists in many platforms allowing for some flexibility in content delivered to the user, platforms generally lack the ability to provide an intuitive process for the course designer which permits person to person interaction and an intuitive, guided process for the learner to review content, complete exercises and interact one-on-one with their teacher. This lack of process around course design, delivery, and learning experience makes current online learning platforms difficult to implement from many aspects.

Another, more involved problem revolves around using technology in the form of web based platforms to facilitate the same interactive teaching and learning process that takes place in a traditional brick and mortar classroom; the interactive relationships between the teacher and the learner and between one learner and another. Prior art platforms require relationships to revolve around a developed course. For example, a teacher designs a course and is responsible for teaching a “classroom” of students who are assigned to the course, but lacks the means to interact in a group or one-on-one in emulation of what is known as the Socratic method or its 20^{th} century descendant the Harkness method. Another example of that which inhibits the teacher student relationship is the rote memorization, static nature of many online platforms.

There is a need for a learning platform that allows for easy language translations within the content management system and user profiles. There is also a need for more cost effectiveness via less IT involvement (hence expense) in customization of learning platform design, course content creation and feature implementation, for programs of any size. This requires a logical presentation of the end user process within the content management system that the course designer or teacher uses, as well as the correct tools to easily upload multimedia content and deliver the desired learning outcomes via a relationally nuanced teaching processes to the learner.

### SUMMARY

Presented herein is an interactive teaching and learning system and method. In one aspect, the interactive teaching and learning system is a web-based cloud application in the form of a learning, course design, teaching and communication portal. The system, in an exemplified aspect, utilizes a MVC (Model-View-Controller) framework written in the PHP programming language with a MySQL database. It can support a content management system, user profiles including a super administrator, general administrators, coaches (teachers), and candidates (learners).

The interactive teaching and learning system, in one exemplified aspect, is presented in the form of a hierarchy of websites in which, by way of the content management system, new modules or course segments can be added as blank modules or become translations of the previous course segments as additional websites are added to the platform. In this aspect, each website is identified as a new partner, with its own general administrator, coaches and candidates.

In one embodiment, the system is operable as method for facilitating education over an electronic network. The method includes the following steps: (a) electronically displaying a course management interface useful to manage an educational course taught by a teacher, wherein the educational course has a sequence of course segments to provide an educational experience for a student; (b) for each one of the course segments, electronically receiving from the teacher, a plurality of course management inputs during the educational course based on the educational experience, wherein each one of the course segments is associated with variable course content; (c) electronically displaying to the student, a course session interface useful to receive the educational experience through the sequence of course segments, wherein the course session interface includes a course navigation menu, and wherein the course navigation menu indicates the sequence of course segments; (d) electronically receiving from the student, a selection of one of the course segments; and (e) electronically outputting to the student, a course output associated with the selected course segment, wherein the course output includes at least part of the variable course content associated with the selected course segment.

In one embodiment, the method includes electronically receiving at least one of a plurality of inputs, including, but not limited, to: (i) a page input for the teacher to add an electronic page or webpage, (ii) a content creation input for the teacher to create at least part of the variable course content within the electronic page, (iii) a document input for the teacher to incorporate an electronic document into the electronic page, wherein the electronic document is part of the variable course content, and (iv) an instruction input for the teacher to add an instruction related to at least part of the variable course content.

In one embodiment, the method includes: (i) enabling the teacher, through the course management interface, to electronically request a student feedback from the student related to the electronic document; (ii) electronically displaying the student feedback to the teacher at the course management interface; (iii) electronically receiving from the student, at least a partially completed version of the electronic document, which is accessible; (iv) electronically providing the teacher with access to the received version of the electronic document through the course management interface; (v) electronically receiving a teacher feedback from the teacher related to the received version of the electronic document; and (f) electronically providing the student with access to the teacher feedback through the course session interface.

In one embodiment, the method includes electronically receiving from the teacher, a downloadable homework assignment document. In one embodiment, the method includes electronically receiving from the student, an upload input to enable the student to upload a completed version of the downloadable assignment document. In one embodiment, the method includes receiving a notice input from the teacher to incorporate a notice into the electronic page with respect to at least part of the variable course content.

Other aspects and embodiments of the interactive learning system and method are described herein. This description is meant to fully describe the interactive teaching and learning system and method, but not limit its design, function, or application.

### BRIEF DESCRIPTION OF THE DRAWINGS

These and other features of the preferred embodiments of the present invention will become more apparent in the detailed description in which reference is made to the appended drawings wherein:

FIG. 1A is an example of the first part of a data map of an interactive learning system, showing a plurality of software modules;

FIG. 1B is an example of the second part of a data map of an interactive learning system, showing additional software modules;

FIG. 10 is an example of the third part of a data map of an interactive learning system, showing further software modules;

FIG. 2 is one example of a partner site collective/translation map of an interactive learning system;

FIG. 3 is one example of a super administrator permissions flow chart of an interactive learning system;

FIG. 4 is one example of a general administrator permissions flow chart of an interactive learning system;

FIG. 5 is one example of a coach/teacher permissions flow chart of an interactive learning system;

FIG. 6 is one example of a candidate/learner permissions flow chart of an interactive learning system;

FIG. 7 is one example of a graphical user interface showing administrator/coach timeline view & functions of an interactive learning system;

FIG. 8 is one example of a graphical user interface showing candidate timeline view & functions of an interactive learning system; and

FIG. 9 is one example of a graphical user interface showing the reporting function of an interactive learning system.

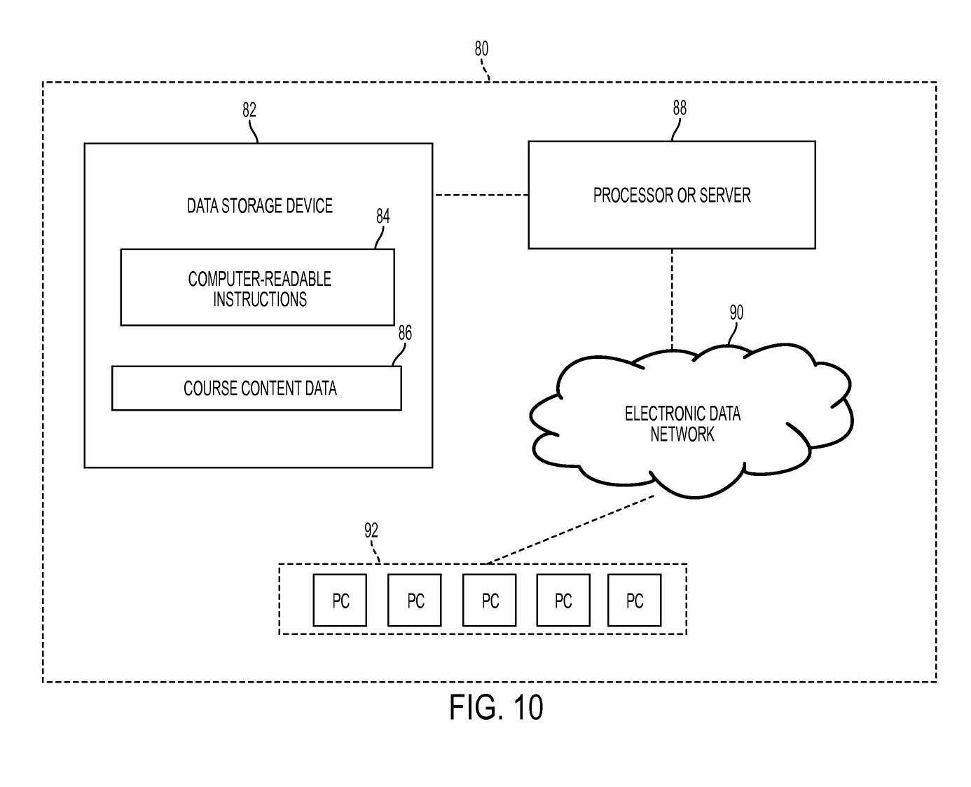

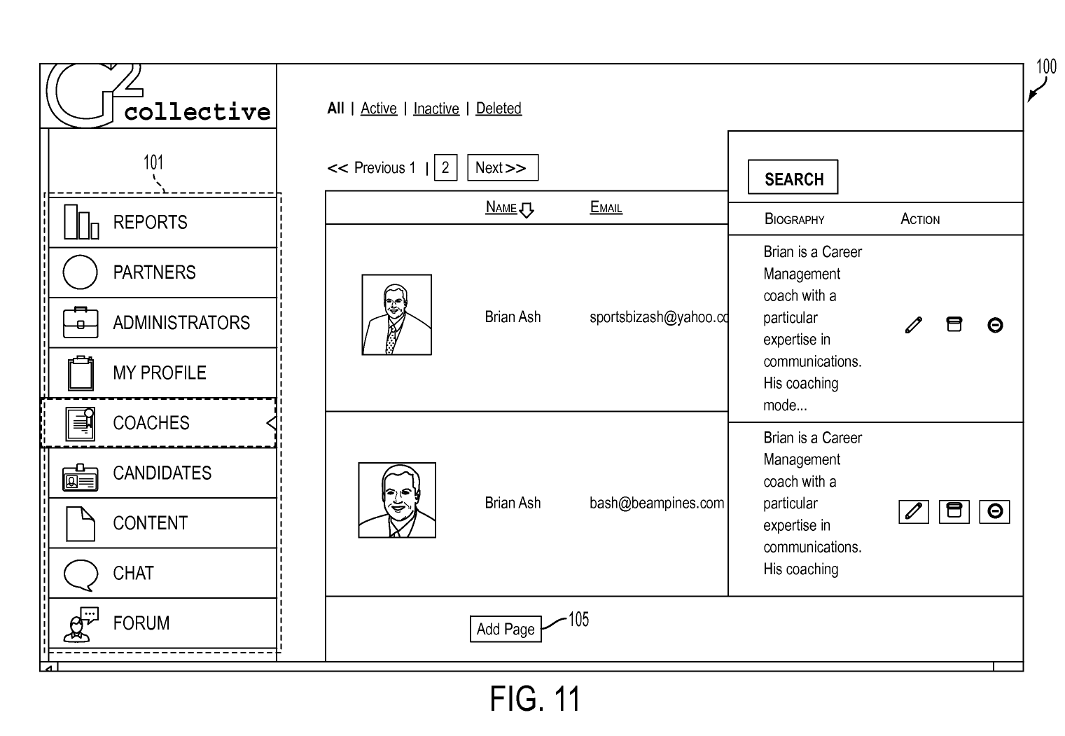

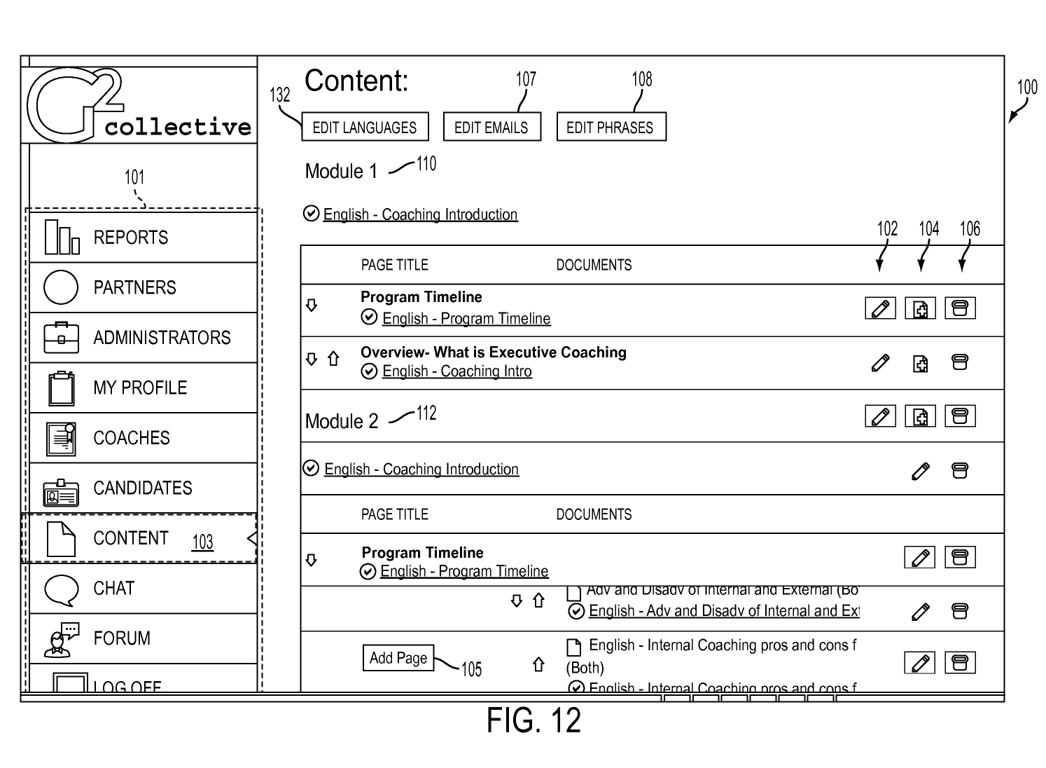

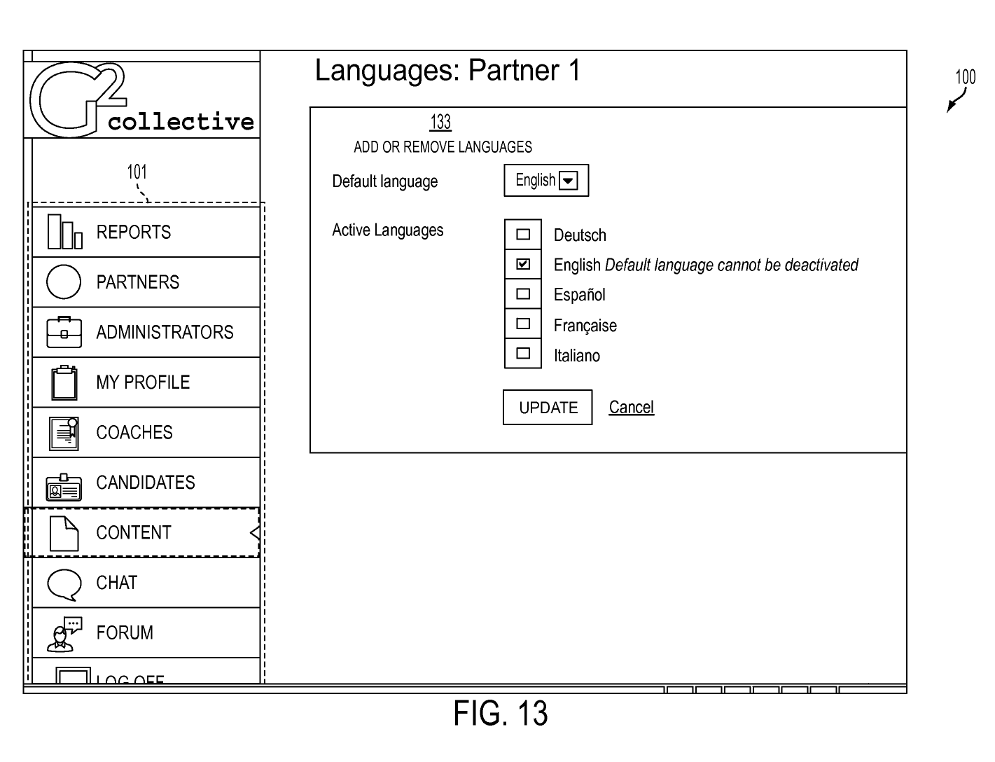

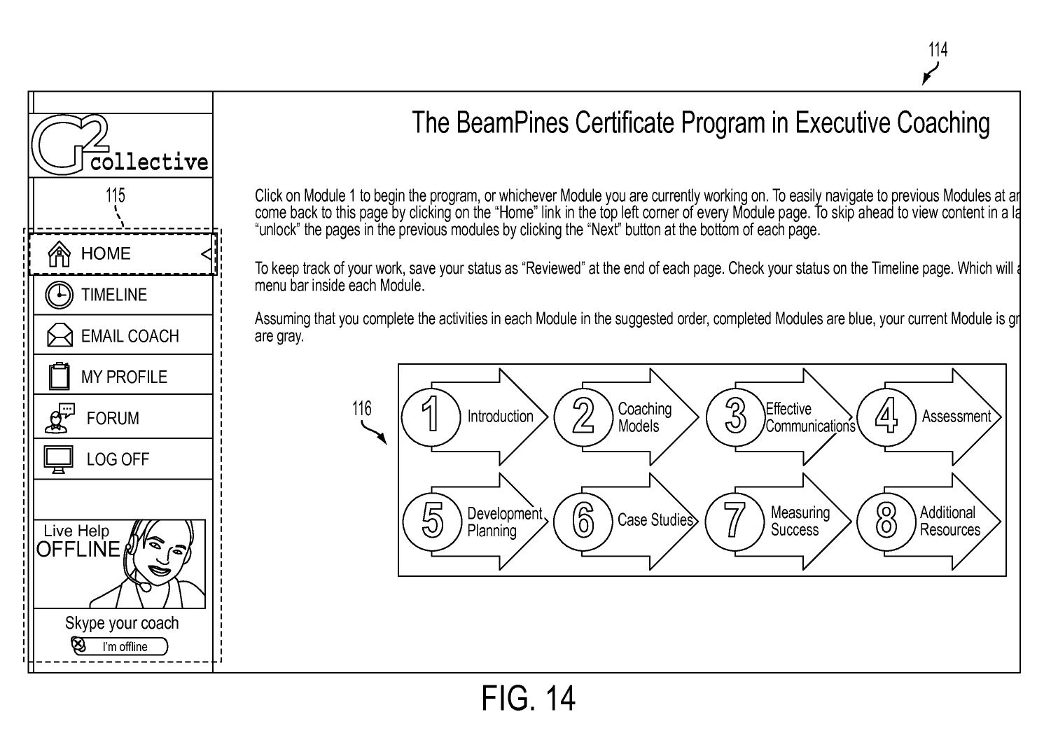

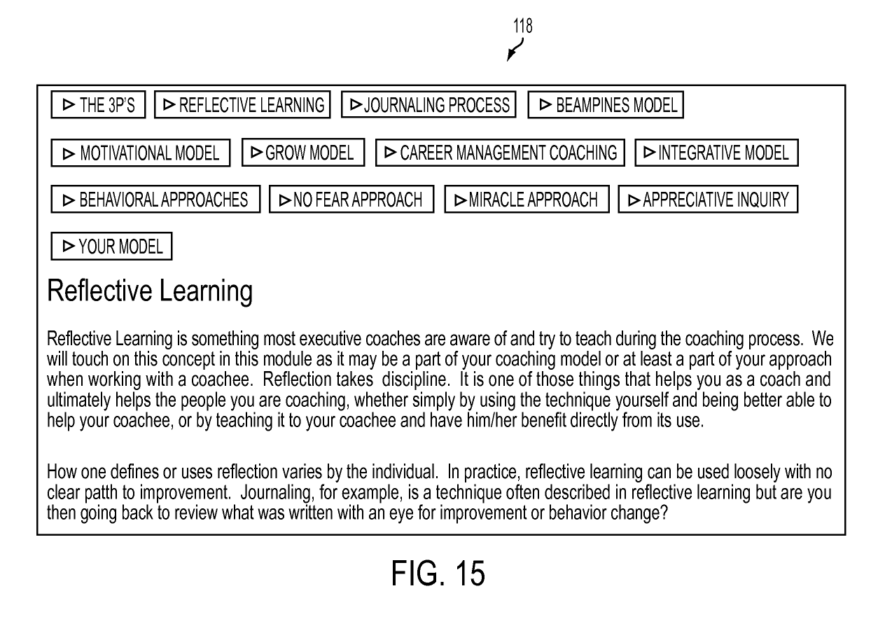

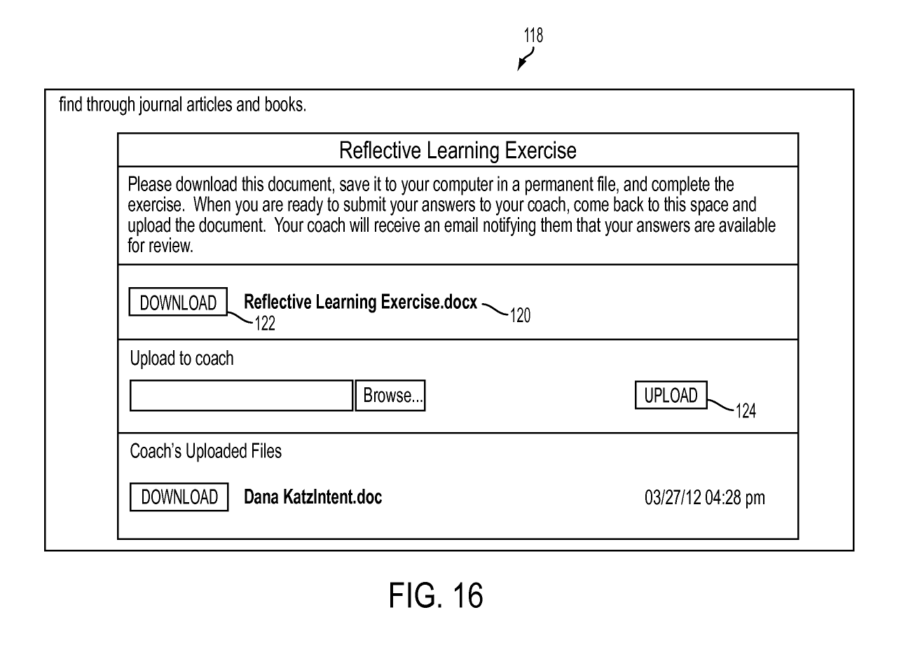

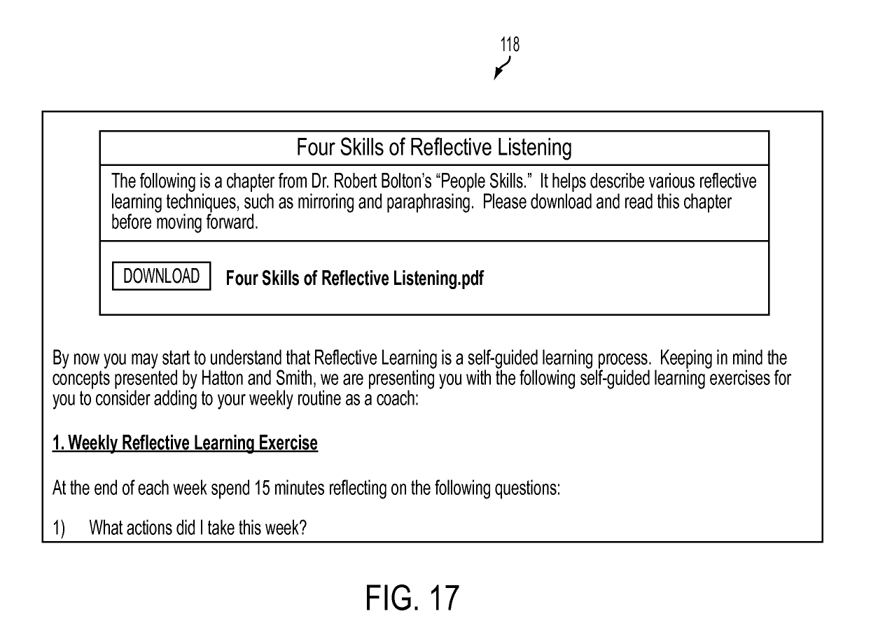

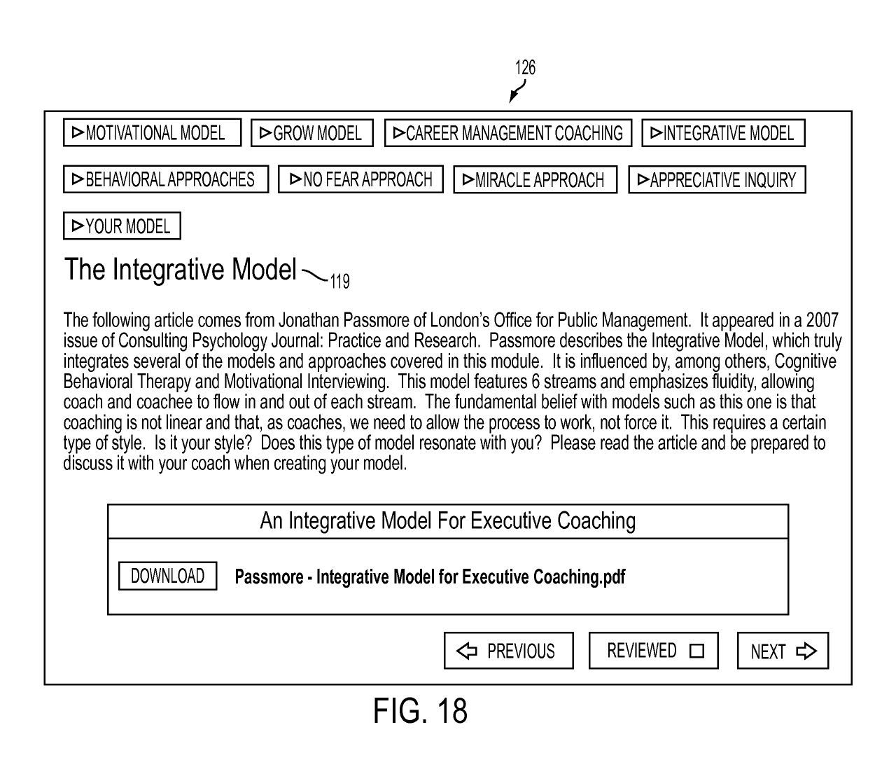

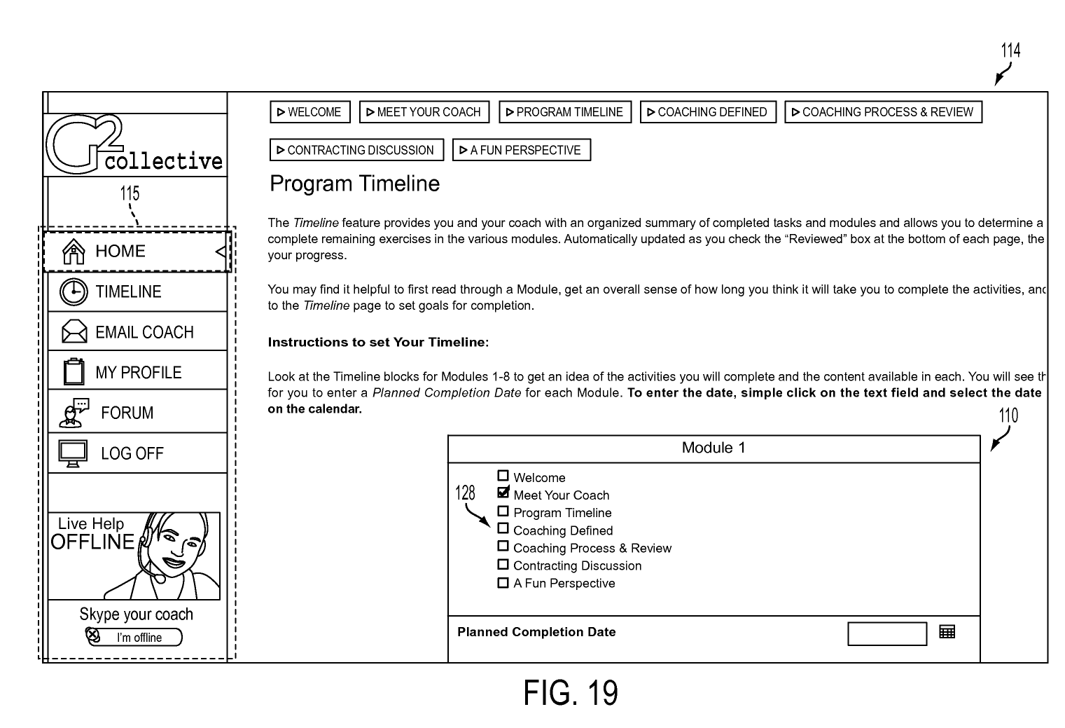

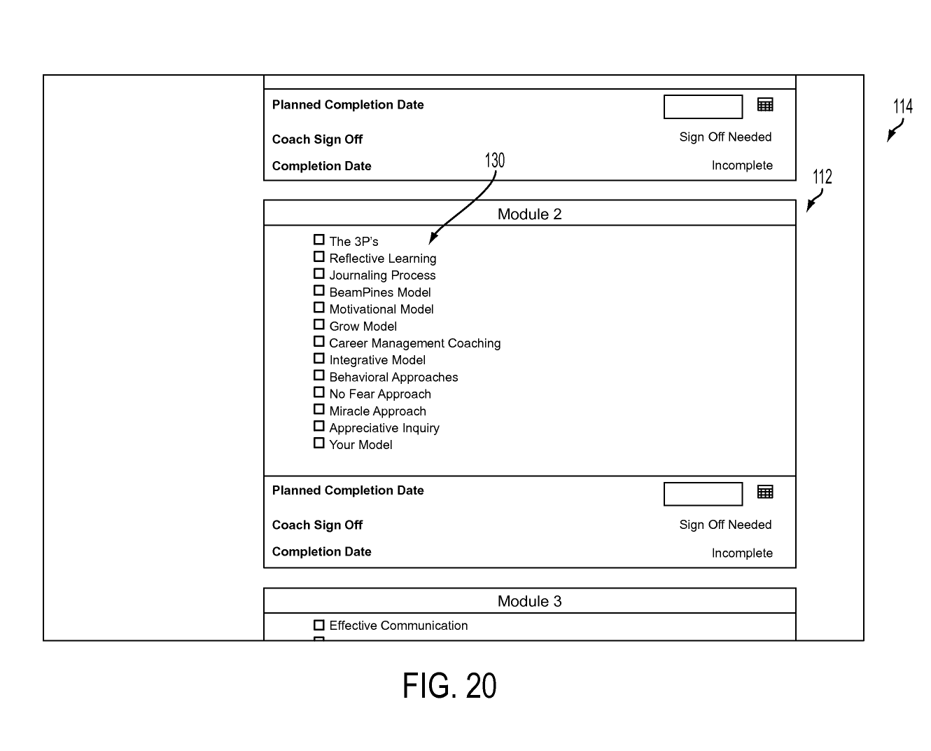

FIG. 10 is a schematic, block diagram illustrating one embodiment of the system.

FIG. 11 is one example of one embodiment of a course management interface of the system.

FIG. 12 is one example of one embodiment of a course design interface of a course management interface of the system.

FIG. 13 is one example of one embodiment of a language change interface of a course management interface of the system.

FIG. 14 is one example of one embodiment of a course session interface of the system, illustrating the course navigation menu.

FIG. 15 is one example of one embodiment of a course session interface of the system, illustrating content associated with one of the modules or course segments.

FIG. 16 is one example of one embodiment of a course session interface of the system, illustrating a downloadable homework assignment embedded as part of the course content associated with one of the modules or course segments.

FIG. 17 is another example of one embodiment of a course session interface of the system, illustrating a downloadable homework assignment embedded as part of the course content associated with one of the modules or course segments.

FIG. 18 is yet another example of one embodiment of a course session interface of the system, illustrating a downloadable homework assignment embedded as part of the course content associated with one of the modules or course segments.

FIG. 19 is one example of one embodiment of a timeline course session interface of the system, illustrating a checklist of course tasks associated with one of the modules or course segments.

FIG. 20 is one example of one embodiment of a timeline course session interface of the system, illustrating a checklist of course tasks associated with another one of the modules or course segments.

### DETAILED DESCRIPTION

The present systems and apparatuses and methods are understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial method, process and results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a data set” can include two or more such data sets unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

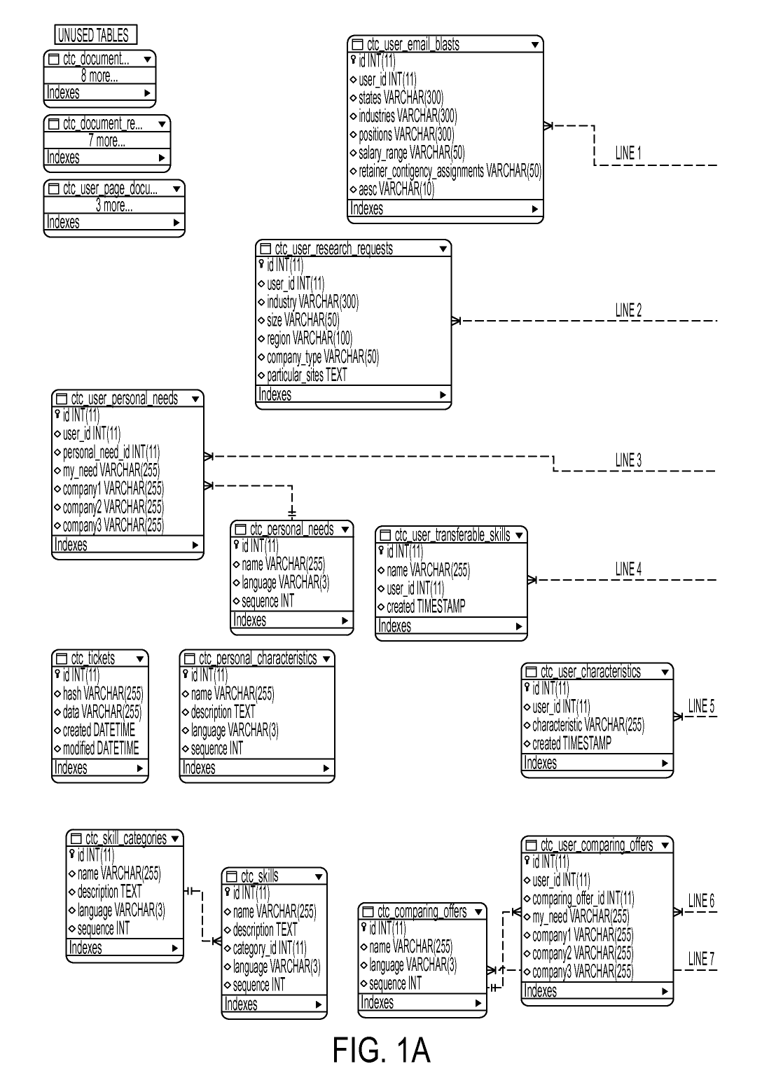

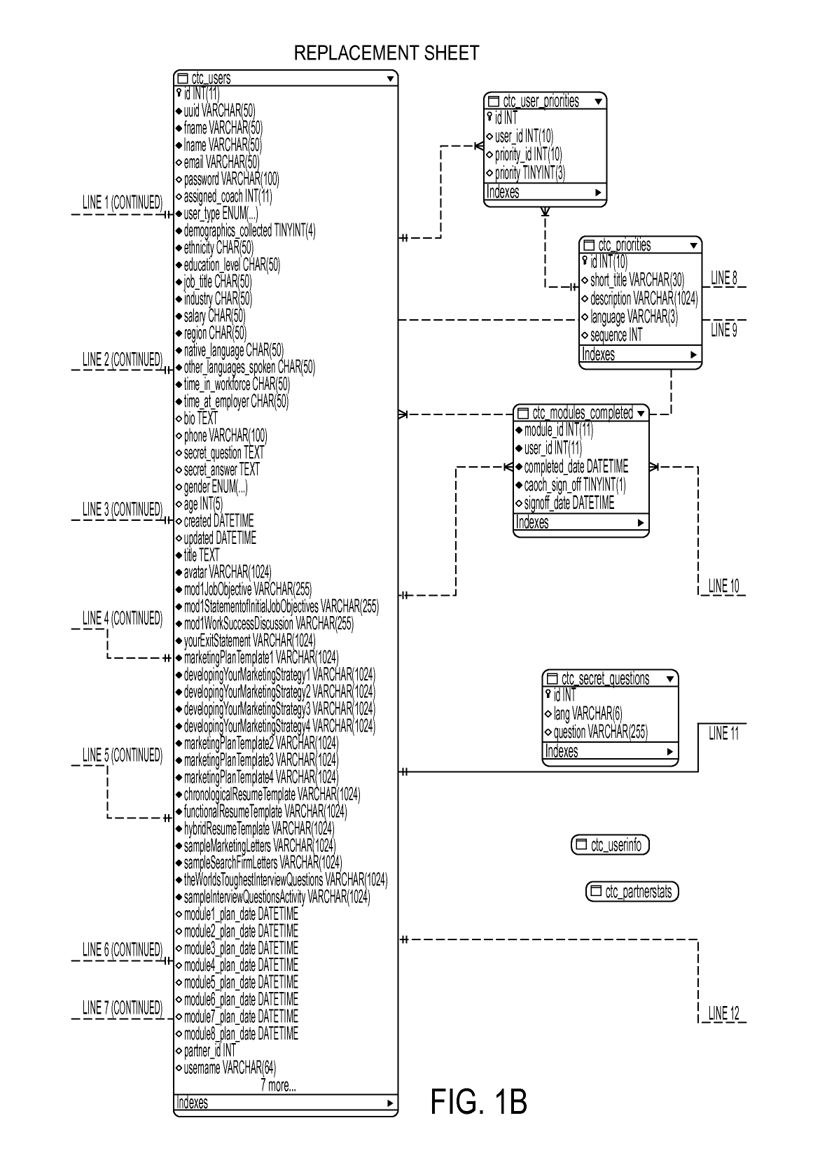

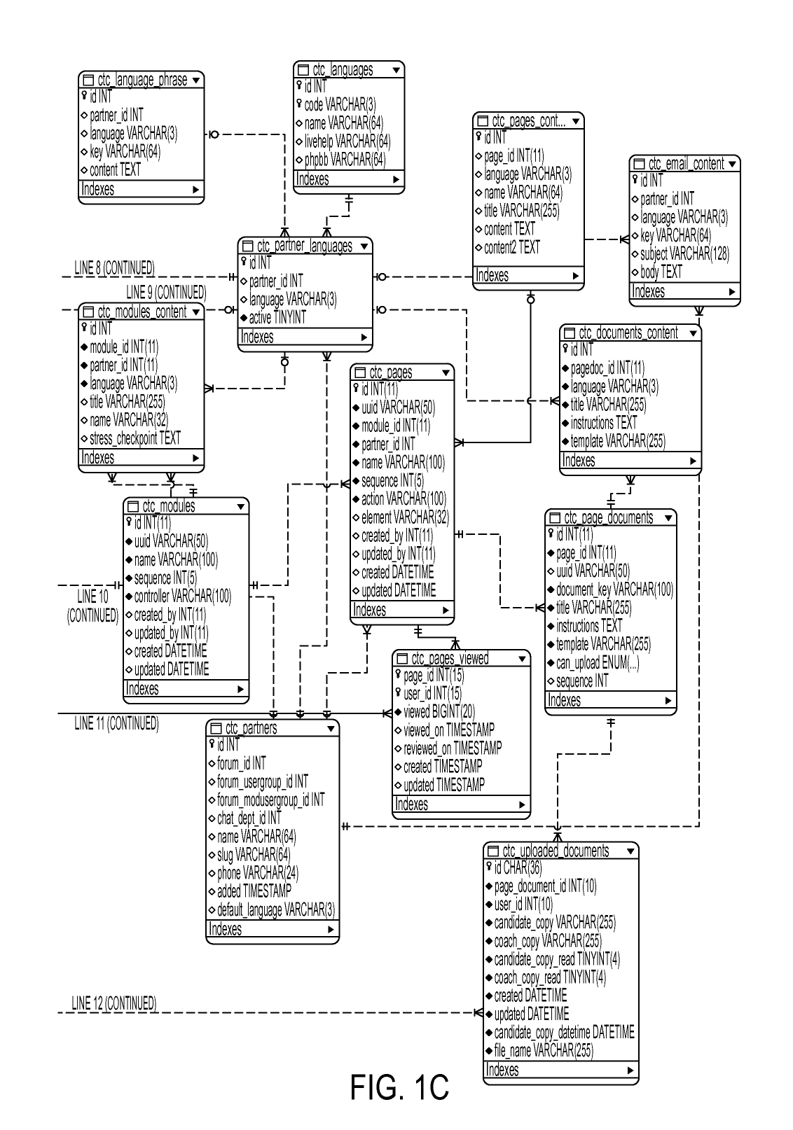

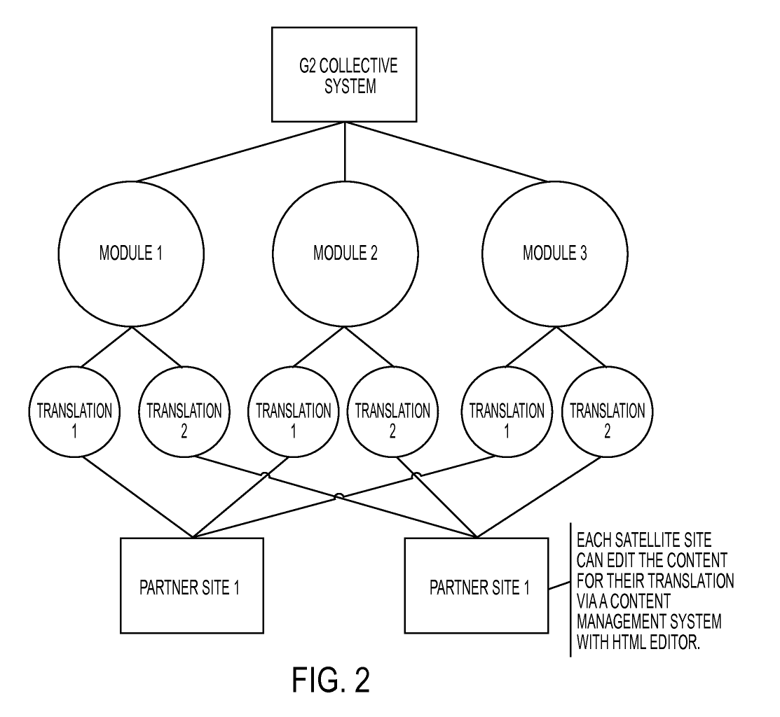

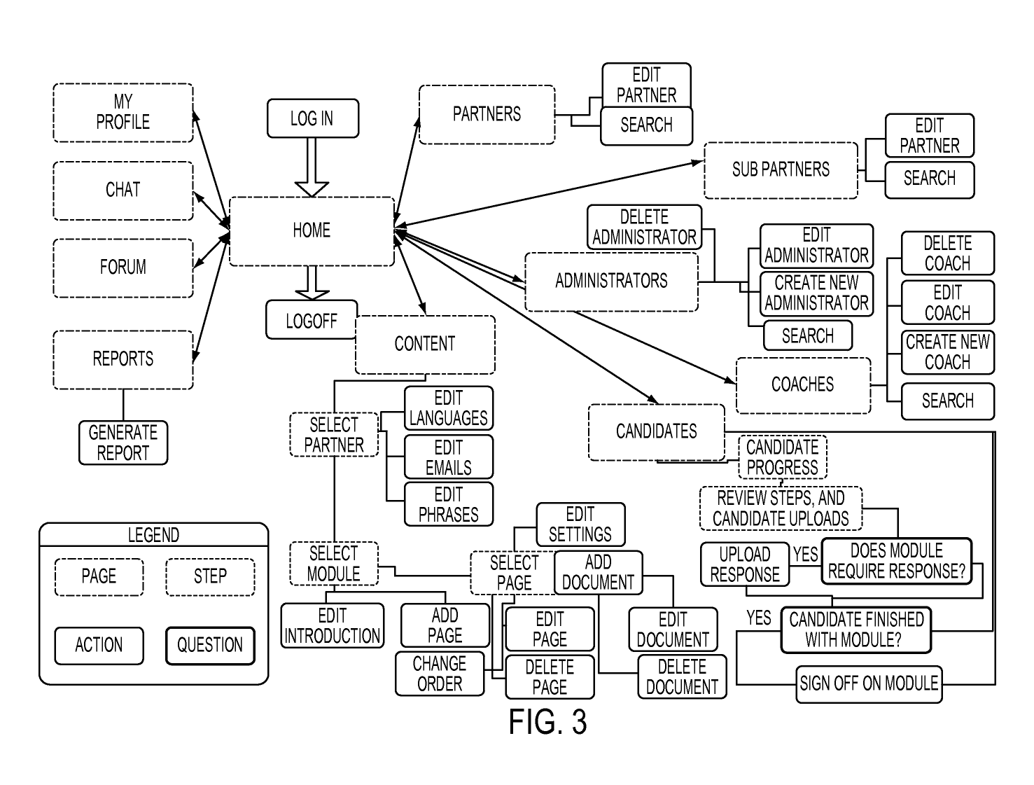

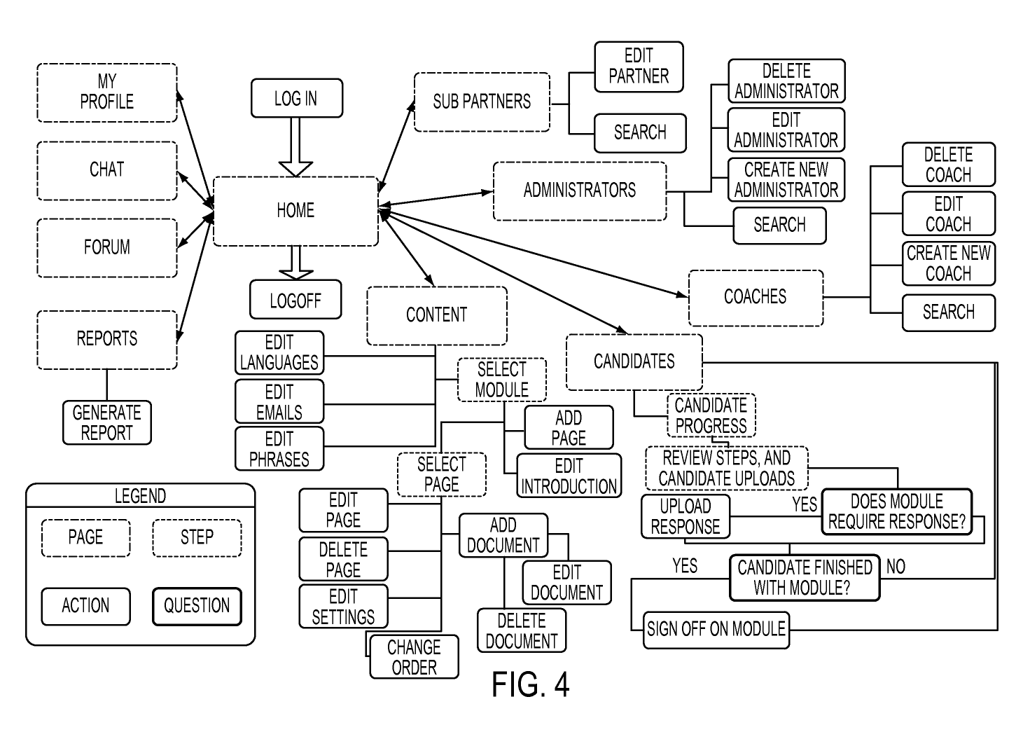

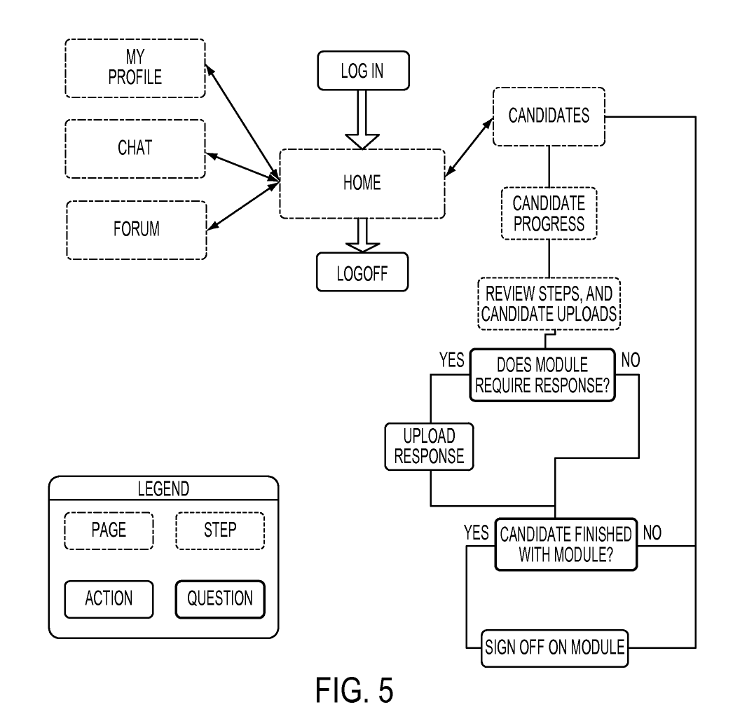

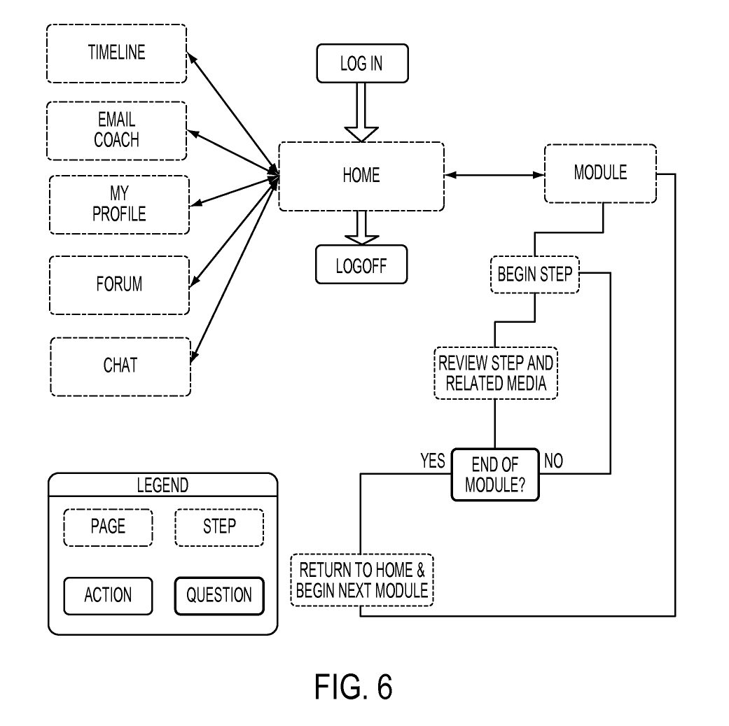

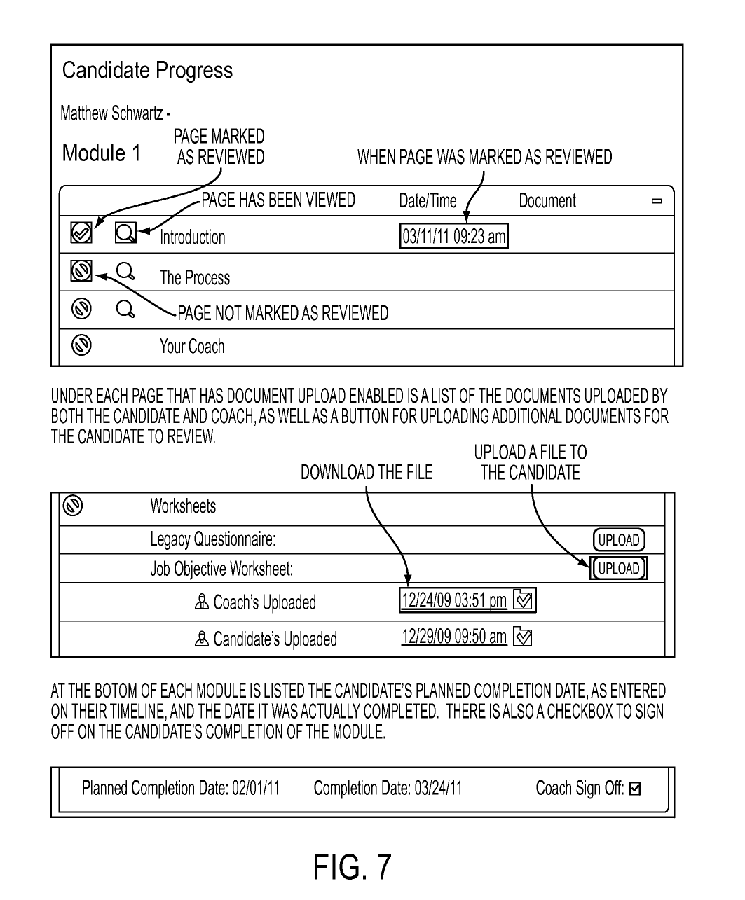

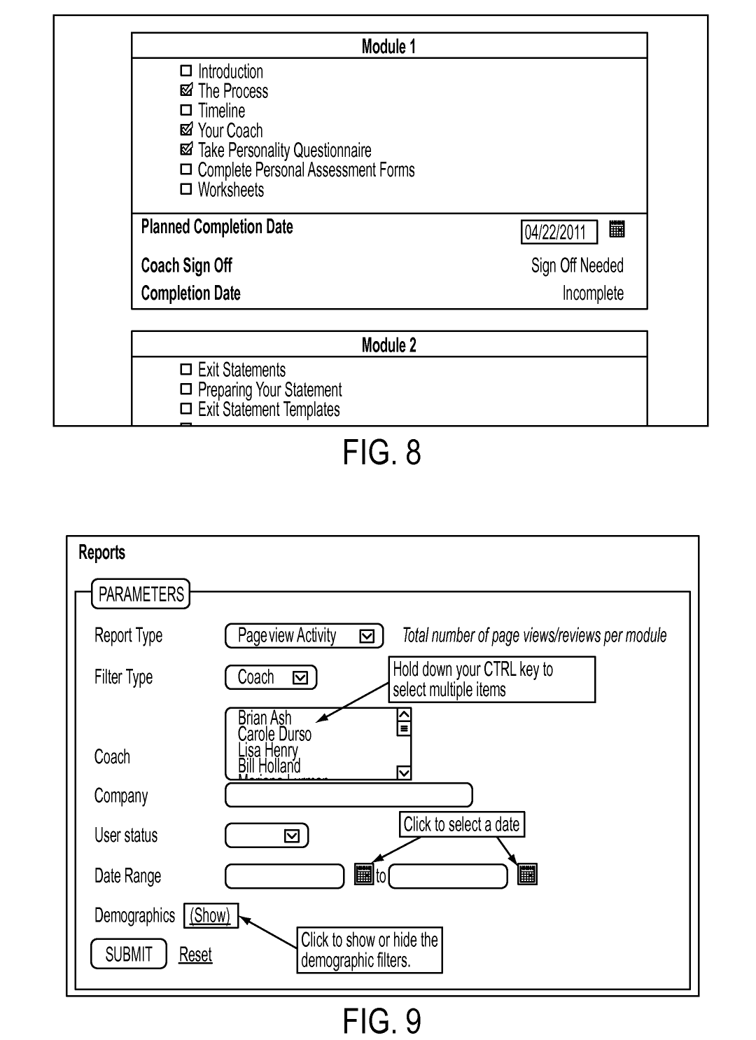

Presented herein is an interactive teaching and learning system and method. In one aspect, the interactive teaching and learning system is a web-based cloud application in the form of a course design, teaching, learning and communication portal. The system, in an exemplified aspect, utilizes a MVC (Model-View-Controller) framework written in the PHP programming language with a MySQL database. It can support a content management system, user profiles including a super administrator, general administrators, coaches (teachers), and candidates (learners). Third-party open source applications can be integrated via customized API to provide communication tools, such as an automatic email system, a forum, and a live chat function. In addition, in another aspect, the system has a built in tracking system that tracks usage details of all parties and other identified variables that the administrator requests in order to generate reports on a variety of identified usage and variables through the built-in reporting function. In yet another aspect, the application can also be configured to build custom modules, course segments or “phrases”, which can become permanent actions that can be added to any module or course segment in the content management system. These phrases can generally consist of custom surveys or forms that can be submitted to an identified user. A data map of the application is shown in FIG. 1.

The interactive teaching and learning system, in one exemplified aspect, is presented in the form of a hierarchy of websites in which, by way of the content management system, new modules or course segments can be added as blank course segments or become translations of the previous course segments as additional websites are added to the platform. The terms “module” and “course segment” are used interchangeably to describe one of several components, portions, stages or phases of an educational course. In one aspect, each website is identified as a new partner, with its own general administrator, coaches/teachers/instructors and candidates/students/participants. It is the super administrator function that has access to the “collective” of data and partner websites as it grows as a whole. One of the unique and highly useful features is that there can be an infinite number of partner websites. One aspect of this relationship is illustrated in FIG. 2.

The Content Management System (CMS) can be accessed through the super administrator portal or general administrator portal. In one aspect, the difference between the two is that the super administrator has access to all of the sub-sites in the system. The general administrator only has access to the CMSs to which they have been assigned and are blocked off from the rest of the CMS systems in the “collective” by firewalls. To edit content within a sub-site, the admin is provided a list of the names of the sub-sites they have access to and when the admin clicks on that name they are directed to a content map of the learning material that is broken down into multiple course segments, pages within course segments and documents within pages.

For each module or course segment, page and document, the admin can also select the language for which they are editing. Of course, any variety of languages can be resident in the platform. For example, and not meant to be limiting, English, French, Spanish, Deutsch, and Italian. However, it can be appreciated that the platform is structured so that new languages can be added at any time. Some or all of the languages can also be supported by the Chat software and the Forum software.

In other aspects of the system, the CMS can include the ability to edit the languages available for the user to choose when they login or within their profile, the ability to edit automated notification emails and the ability to edit phrases, which are customized pages that have special features which are not part of the regular page features within a module or course segment (e.g. custom built survey pages, text on the sub-site home page, a copyright notice (or any notice) viewed on the login page).

Within the CMS, the learning content can be visually presented in a list that mirrors the process in which the learners view the content and complete activities. Current modules or course segments are numbered, for example 1-8. They are easiest compared to chapters of a book. To name a module or course segment, a user can click on the language that they would like to edit underneath the course segment number and have the option to enter a Name for that course segment in a field. The name that is entered here is the name that the learner sees on the course segment icon on their homepage.

Pages can be listed under each course segment and identified by the title that the admin gives to the page. The admin can add a plurality of pages, per their choice. In one aspect, this is done by clicking on the add page button for the specified course segment. When the button is clicked, a field pops up in which the required information to create a page can be entered. Exemplified information entered can be a page title and an Element. The page title is the title that the learner sees as a tab when they are inside the course segment. The Element refers to the features of the page. In the alternative, selecting the element, “None,” creates a page that doesn't have any special features. Pages with elements are pages that require “phrases” as mentioned previously. This is the way to insert a custom built survey within any course segment, a way to substantially automatically insert a page that is connected with a user and shares data about them (for example, automatically insert the biography of the teacher that is assigned to a learner), a custom built form that asks the learner to select criteria and submit their selections for review, or a page that shows the content/course timeline and its interactive features. This timeline is substantially the same as the list that the admin sees in the CMS, separated, by Course segments and pages, but can exclude certain details such as documents and language options.

There can also be a button to edit the page settings (title and element) at any time after creating a page, as well as a button to delete the page.

In another aspect, to add content or edit the content of a page after the page is inserted, clicking on the name of the language a user wants to edit the page in (languages are listed under the page title) will bring the admin to a new page which contains a field for the page name, a field for the page title, WYSIWYG (what you see is what you get) content editors for regular page content and footer content, buttons for saving, previewing or canceling work, and a content preview section.

The Page Name entered can be reflected on buttons and navigation pertaining to that page that the learner sees within that course segment. The page title, in one aspect, shows up above the content on the page when the learner is viewing that page in the learning portal. The WYSIWYG editor can contain features available for basic word processing, HTML source editing, and adding and/or editing images and multimedia files. There can be a plurality of WYSIWG editors available for each page to increase formatting flexibility on pages. In one aspect, if a Document is inserted on a page and the admin wants to continue with text content on that same page underneath the document window, the footer WYSWYG editor becomes available because of the break in the content that the WYSIWYG editor supports. (Documents are, in this aspect, inserted outside of the WYSIWYG editor as a substantially different function for interactive communication purposes). Clicking on the Preview button after adding content into the editors allows the admin to see what the content will look like in the dedicated preview section at the bottom of this page. Clicking on the Save button deploys the content immediately and makes it go live and visible to the learners with access to the specified sub-site. Clicking on the Cancel button deletes any changes made since the last Save and directs the admin back to the Course segment content list. As can be appreciated, each Language available can have its own editing space for each Page.

In another aspect, the CMS also allows the admin to insert fields on pages that allow the teachers and learners to upload and download documents as a means of completing activities and coursework when there is a need to use the content outside of the system, and when there is a need for feedback to be exchanged between the teacher and the learner around the activity. Scenarios for adding a document field to a page can include, for example and not meant to be limiting, 1) to make content available that a learner can upload to their computer and manipulate, modify, print or do anything they would need to with that document outside of the platform; 2) to make a designated “space” available for a learner to submit work product to a teacher; 3) to make a space available for the learner and the teacher to go back and forth uploading and downloading work product and feedback (continuous editing process); 4) to make a designated space available for a teacher to share a document with their student, such as a progress report, assessment/survey results, and the like.

In this aspect, documents can be added to a page by clicking on the “Add a document” icon for that given page. Then, a field pops up which requires the admin to name the document and select the uploading permissions for the document. Uploading permissions determine who can upload a document to the document field. In another aspect, permission choices include: Learner only, Teacher only, both Learner and Teacher, and nobody. These permission options enable required functions to fulfill the listed scenarios for adding a document field to a page. Once the document field is added, it is listed by title on the course segment content list in the CMS. It is listed at an indent underneath the page where it exists. Underneath the document title, the admin has the choice to edit the document in all languages, just like editing pages. To edit the document, the admin clicks on the desired language and is taken to a page with a field that lets the admin upload a document template (can be any file type). There is also a field that allows the admin to enter instructions for what the learner is supposed to do with the document. There is a Save button on this page which deploys the document immediately and makes it go live and accessible to the users who have been granted access to the sub-site. There is also a Cancel button which deletes any changes that have been made since the last Save and directs the admin back to the Course segment content list in the CMS.

Each time a learner uploads a document to a document field, their assigned teacher can be sent an automated email to notify them that a new document is available for them to upload and review. The teacher can upload this document from their own Teacher portal (explained later). Accordingly, each time a teacher uploads a document for a learner to review, the learner is sent an automated email to notify them that the document is available and where to find it within the course segments and pages. These automated emails are examples of content that is edited in the Phrases section of the CMS.

In one aspect, there are a plurality of user levels within the system. For example, Super Administrator, General Administrator, Coach/Teacher/Instructor, and Candidate/Learner/Student. Each user level can have different permissions as to which pages they are able to view, and are able to take certain Steps to complete certain Actions.

In an exemplified aspect, the Super Administrator is the only user that has access to everything within the application framework, content and data within all Partner sites (sub-sites). The Super Admin can edit information within its own profile. Profile information is used to identify users when they are linked together in various teaching/learning/administrative relationships and when they are communicating throughout different parts of the collective, such as the forum or chat discussions. The Super Admin has full access to all Partner sites and is able to edit their Administrators, Coaches and Candidates, and Content. The Super Admin is also able to view and monitor all chat, forum and email conversations within the collective. They also have the ability to run reports on any data within the collective (e.g. a report on global users, users within a given Partner site, or even zero in on one coach's or candidate's data, or a group of coach and/or candidate data). This is shown in FIG. 3.

In some aspects, the General Administrator can to perform the same functions as the Super Administrator, but only within the sub-sites for which they have administrative permission. This means that they only have access to Teacher and Learner information, content and communications within the permitted sub-site(s), and can only run reports on information generated within those sub-site(s). This is exemplified in FIG. 4.

In another aspect, coaches/Teachers can access information on Candidates/Learners to which they have been assigned. A Teacher is created by either a Super Administrator or a General Administrator and assigned to a sub-site for which they will be teaching the content. Coaches/Teachers are able to make changes to their own profile, chat with their Candidates/Learners, participate in forum discussions, create new Candidates/Learners, view their Candidates/Learners progress, upload documents for their candidates/learners and sign off on their Candidates'/Learners' work. This relationship is shown in FIG. 5.

In yet another aspect, Candidates/Learners can access their own portal, which consists of the content in the course segments which has been inserted by the administrator for the sub-site they have been assigned to, their own work product within these course segments, their own interactive program timeline and their profile. They also have the ability to email their Coach/Teacher directly through the portal, request a chat session with a Coach who is online, and participate in forum discussions. This relationship is exemplified in FIG. 6.

In an exemplified aspect, upon logging in, the candidate/learner sees a guided learning process throughout the course segments, pages and documents that were created in the content management system. When a new candidate/learner profile is created, the user who creates the initial profile sets a permission for either sequential or random viewing of course segments and pages depending on how they prefer to present the content to the learner. Sequential viewing is helpful when the teacher wants to deliver information in a controlled, specific order. In this case, the candidate must view each course segment and page within the course segments, and unlock each page by clicking a button that takes them to the next page. Sequential viewing is also helpful when a teacher wants to ensure that a learner completes certain work product in a specific order. For example, there can be built in “phrases” (such as a survey or test) that must be completed before moving forward. Random viewing unlocks all of the pages and is helpful in situations where the information flow process is open and the learner might need access to all information within the course segments simultaneously to achieve learning program goals. The ability to set viewing order as Sequential or Random is a tool that the Teacher can use to guide Students as individuals and/or groups through the interactive learning process for each course.

The interactive timeline serves many purposes for all users. For Administrators, the timeline is a map of the course material and the order and format in which it will be delivered to the learner, a quality control tool, and the basis for running usage reports. For the Coach/Teacher, the timeline is the interactive work space in which they keep track of their Candidates'/Learners' progress, download material uploaded by the candidate, upload material and feedback to the candidate, keep track of completion dates/times and feedback dates/times, and sign off on work the Candidate/Learner completes. For the Candidate/Learner, it also serves as a way to keep track of what has been completed, signed off, and an overview of the content in the course segments, like a course syllabus. It also has a goal setting tool which allows candidates to pick out dates which they would like to have completed course segments, which reflect on the Coaches view of the timeline as well.

On the Administrator and the Coach/teacher view of the timeline, there are symbols next to the title of each page that indicate if a page has been viewed by the candidate, marked as completed by the candidate, or not viewed at all. When a candidate uploads a document, a folder icon appears on the timeline next to the document title, so that the coach can login and click on the folder to download the document. The coach can then click on an upload button next to the folder icon, and upload a document with comments and feedback on the work product. Refer to FIG. 7, which illustrates the Administrator/Coach Timeline View & Functions. Time restrictions can be set to remind the coach/teacher to respond to a candidate's upload within a certain time period. For example, if a user wants the coach to respond to the candidate within 24 hours of receiving a document, the restriction can be set to 24 hours, and if the coach doesn't upload anything within that time period a red message that says “Coach's response needed” appears on the timeline under the candidate's document. There is substantially no limit to how many documents can be uploaded back and forth between candidate and coach, and all iterations of the document are stored in the coaches and admin timelines and database. Administrators view the timeline in the exact same format as the coach.

In another aspect, Candidate's however, do not access the documents on their timeline, and only have direct access to their own latest upload and their coach's latest upload. They access these documents in the upload/download windows on the pages within course segments that instruct them to complete the work product. What candidates do see is checkmarks on the timeline next to the pages that they have marked as reviewed, what their planned course segment completion dates are, and whether or not their coach has signed off on course segments. FIG. 8 illustrates Candidate Timeline View & Functions.

The system Super Administrator and General Administrator user portals can have built in reporting functions. The Super Administrator can run reports on all data existing within the entire collective of sub-sites. General Administrators, in one aspect, can only report on data within the sub-sites they are assigned to. Reporting parameters can be set around Report Type (Page view activity, Course segment page view activity, user history, and/or an overall usage summary), Partner/Sub-site, Filter Type (Coach, Candidate), Individual Coaches, Company, User Status (Active, Inactive), and Date Range. In addition to these basic filters, other filters, such as demographic filters using variables/information that the candidates have provided for their profile (education level, ethnicity, languages spoken, salary level, job title, geographic region, industry, etc.) can be utilized. These parameters and variables allow Administrators to run reports on application usage data and on any number or group of candidates and coaches. For example, if a user wanted to know how many page views occurred between a date range within a predetermined Course segment by the candidates of a first company being coached by a first coach, this selection can be submitted, run through the database and generate a bar graph with the data, as well as the option to see raw data. Depending on the program goals for the teachers, learners and companies, reporting variables can be changed/added to include any information that will be helpful for the given sub-site's administrators and users. Reported data is generally helpful for decision making, quality control, growth tracking and marketing data generation. FIG. 9 shows one aspect of a Reporting Function.

In one aspect, methods of communication within system are focused around well established, proven learning protocols: content delivery, inquiry, discussion, and giving and receiving feedback. To facilitate, third-party open source applications can be integrated via customized API to provide communication tools such as an automatic email system, a forum, and a live chat function.

At any time, the application structure can support the integration of new third party apps. In one aspect, the uploading/downloading fields are checkpoints that prompt the production of work product wherever they are placed in the program, and encourage and direct the giving and receiving feedback process at specified times depending on where they are placed within the course segments and the pages.

Accordingly, the course designer can use the placement of these windows to control and determine the “labor intensity” or estimated work hours that the teachers and learners will be spending in the feedback process, which like editing and grading papers is often the most time consuming part of the work that is done by the teacher.

As can be appreciated by those skilled in the art, by using a cloud environment to facilitate the teaching and learning experience, thereby foregoing the need to download special software, there is a low cost point of entry for recipients of training and an increase in efficiency and flexibility of teaching opportunities.

Since, in many aspects, the application is cloud based, it can facilitate a growing collection of knowledge/data at increasingly rapid rate as sub-sites, course segment translations and general content are created and connected. As such, integrating open-ended data search tools and other knowledge mining tools into the collective database is contemplated.

As mentioned herein above, there is a plurality of course segments available for all users. The Super Administrator or General Administrator, in one aspect, can add and subtract course segments from the CMS of each sub-site at any given time. In one aspect, these are sub-course segments, and they can take away the restrictions around the number and types of course segment translations within the collective.

In one exemplified aspect, learning and feedback relationships exist between learners/candidates and teachers/coaches. In order to facilitate group learning, feedback and project work, the system can also allow administrators to assign groups of learners and teachers (unlimited numbers) to each other, and a shared workspace that the group has access to which appears within their personal portals. This permits them to share information and upload/download and give feedback on group documents, as well as chat with each other and make updates in real time. In another aspect, the group workspace can integrate live webinar and screen sharing technologies to facilitate real-time collaboration. Much of the communication and webinar tools can be added via third party API.

Naturally, part of the learning process is evaluation. In one aspect, the CMS allows custom phrases to be added to course segments which can be surveys and/or assessments. In this aspect, they are built separately and then inserted into the system. In another aspect, there is a custom survey/assessment builder added directly into the CMS so that assessment can be more easily, openly integrated into any course segment and graded automatically. The builder can include all standard question building tools such as multiple choice, short answer, true/false, matching and open-ended essay. It can also include both formative and summative assessment structures.

In one aspect, the administrators can make certain pages, course segments and assessments available to users or restricted to users within certain time periods. This is useful when teachers want to deliver information on a daily, weekly or monthly basis without the ability to skip ahead, or when there is a crucial timed test on material. It can also help discourage cheating behavior in certain testing environments.

The system can also comprise a live video chat feature, a group project management calendar, and a live video streaming capability to facilitate live event participation.

Referring to FIGS. 10-20, in one embodiment, the system 80 includes a data storage device 82, such as a database or memory device. The data storage device 80 stores one or more software programs, software modules of computer code or computer-readable instructions 84. Also, the data storage device 82 stores variable course content data 86. The data storage device 82 is coupled to a processor or server 88 operating on an electronic data network 90, such as the Internet. In one embodiment, the data storage device 82 is accessible to a plurality of personal computers 92, mobile phones or other network access devices which are connected to the network 90. The processor 88 executes the computer-readable instructions within the data storage device 82 to receive designated inputs from the end users, including, but not limited to, teachers and students, who operate the computers 92. In response, the processor causes the system 80 to generate outputs, such as graphical interfaces or interfaces, graphical representations, transactions, sounds or audiovisual outputs.

In one example illustrated in FIG. 11, the system 80 displays a course management interface 100 to teachers or administrators who are registered users. The course management interface 100 includes a course management menu 101. The course management menu 101 indicates a plurality of software modules, including, without limitation, a reports software module, a partners software module, an administrator software module, an administrator profile software module, a coaches or teachers software module, a candidates software module, a content management software module, a chat communication software module and a forum software module. The system receives inputs associated with a user's selection of these software modules, and the system manages or runs the functionality associated with the selected software modules.

In one embodiment, the software modules of course management menu 101 are incorporated into the system in a modular fashion. In one embodiment, one or more of these software modules can be added to the system or removed from the system without impairing the other aspects of the system.

In one example illustrated in FIG. 12, when the teacher selects the content software module 103, the system displays a course management interface 108. The course management interface 108 enables the teacher to design, modify and manage variable course content for the educational experience of one or more students throughout the course session. The educational course can have a sequence of course segments, which, in one embodiment, are organized in a step-by-step fashion to be completed in chronological order.

In the example shown in FIG. 12, course segments 110 and 112 are identified as “Module 1” and “Module 2,” respectively. For each one of the course segments, the system is operable to receive a plurality of different types of course management inputs 105, 102, 104, and 106 associated with variable course content provided by the teacher or administrator.

In one example, the course management input 105 is an electronic page addition input, enabling the teacher to add and create an electronic page or webpage, such as webpage 118 shown in FIG. 15. The system, in one embodiment, the course management interface 108 includes an editor which enables the teacher to create text and content, including, without limitation, audiovisual content, while within the webpage 118. The system makes the webpage 118 accessible to the student through the course session interface 114 described below.

Referring back to FIG. 12, in one example, the course management input 102 is a profile editor input, enabling the teacher to create or edit the title and other attributes of the webpage 118. The course management input 104 is an electronic document addition input. The teacher can use the electronic document addition input to incorporate desired course content, such as downloadable assignments, into a desired course segment. The course management input 106, in one example, is a delete input, enabling the teacher to remove an electronic document from the system.

In one embodiment, the course management inputs include an instruction input enabling the teacher to add an instruction for the student related to at least part of the variable course content. For example, the teacher may add an assignment document to be completed by the student, accompanied by the instruction, “Read speech aloud before returning outline.” The system displays such instruction to the student through the course session interface 114 described below.

The course management interface 102 enables the teacher to vary the course content throughout the course session depending upon student performance and the progress or status of the educational experience. The course content, when updated by the teacher, is displayed, or made accessible, to the students through the course session interface 114. After the students access the updated content, the students may submit completed assignments for grading or review by the teacher. The system facilitates the interchange by including customizable teacher instructions, teacher feedback, and student feedback.

In one embodiment, the system includes an email alert software module 107 as illustrated in FIG. 12. This module 107 generates alerts to students in the form of emails. The emails are customizable and selectable from a set of form emails. When the teacher adds a document or homework assignment through the course management interface 108, the system automatically sends the associated email alert to the students. For example, an email alert may state, “A new homework exercise has been assigned. Click on the following link to download the exercise.”

To the students or enrollees, the system displays a course session interface 114, as illustrated in FIG. 14. In one embodiment, the course session interface 114 includes a main course session menu 115. The main course session menu 115 identifies a plurality of functional features or software modules, including a home page, a timeline page, an email software module, an account profile software module, a forum software module, a log off software module, and a chat software module. The system receives inputs associated with the user's selection of these software modules, and the system manages or controls the functionality associated with the selected software modules.

In one embodiment, the software modules identified by the main course session menu 115 are incorporated into the system in a modular fashion. In one embodiment, one or more of these software modules can be added to the system or removed from the system without impairing the functionality of the other aspects of the system.

The course session interface 114 enables the students to receive an education through the sequence of course segments. In one embodiment, the course session interface 114 includes a course navigation menu 116 as illustrated in FIG. 14. The course navigation menu 116 indicates the sequence in which the course segments should be, or must be, conducted. In the example illustrated in FIG. 14, the course navigation menu 116 indicates the eight course segments within arrows, labeled numerically, “1” through “8.” In one embodiment, the system enables the teacher or administrator to require the student to successfully complete one of the course segments before proceeding to a subsequent course segment.

Referring to FIG. 15, when the student selects one of the course segments, the system produces course output 118 in the form of the webpage created by the teacher. The output, electronic page or webpage 118 is associated with the selected course segment, as illustrated in FIG. 15. In the example provided in FIGS. 15-16, the course output includes a Reflective Learning Exercise. The student must download the reflective learning exercise document 120 using the download input 122, complete the exercise, and upload the completed document using the upload input 124.

In one embodiment, the course output includes a downloadable homework assignment document accessible at the course session interface 114. In another embodiment, the course output includes a video which is viewable at the course session interface 114.

In another example illustrated in FIG. 18, the course session interface 114 includes a segment topic menu 126, which includes hyperlinks to the different topics of the applicable course segment.

In one embodiment, the system includes a plurality of computer-readable instructions executable by the processor to: (a) enable the teacher to use the course management interface to request a student feedback from the student related to an assignment (in the form of an electronic document or other form) assigned by the teacher, wherein the course session interface displays the request, for example, “Complete this assignment by tomorrow, and double check your quadratic equation calculation.” (b) enable the student to provide the student feedback using the course session interface, wherein the student feedback is displayed to the teacher at the course management interface, for example, “I did my best but had difficulty with the quadratic equation;” (c) receive from the student, at least a partially completed version of the assignment; (d) enable the teacher to access the received version of the assignment; (e) receive a teacher feedback from the teacher related to the received version of the electronic document, for example, “Check your negative signs in the equation;” (f) enable the student to access the teacher feedback; and (g) repeat steps (b) through (e). This loop or cycle of teacher-student interchange facilitates the learning process with ease of use.

In another example illustrated in FIGS. 19-20, the course session interface 114 includes a plurality of timelines or time-tracked checklists 128 and 130 associated with the course segments 110 and 112, respectively. Each such checklist identifies the requirements or tasks of the corresponding course segment. The checklist also indicates whether the requirements or tasks have been completed.

Referring back to FIGS. 12-13, in one embodiment, the course management inputs include a language change input 132 associated with a plurality of different languages, including, but not limited, to English, Spanish, Deutsch, French and Italian. At the language change interface 133, the system receives the language change from the teacher or administrator and automatically translates part or all of the text within the course content from one language to the selected language.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

The invention is claimed as follows:

1. A method for facilitating education over an electronic network, the method comprising:
(a) electronically displaying a course management interface useful to manage an educational course taught by a teacher, the educational course having a sequence of course segments to provide an educational experience for a student;
(b) for each one of the course segments, electronically receiving from the teacher, a plurality of course management inputs during the educational course based on the educational experience, each one of the course segments being associated with variable course content;
(c) electronically displaying to the student, a course session interface useful to receive the educational experience through the sequence of course segments, the course session interface including a course navigation menu, the course navigation menu indicating the sequence of course segments;
(d) electronically receiving from the student, a selection of one of the course segments; and
(e) electronically outputting to the student, a course output associated with the selected course segment, the course output including at least part of the variable course content associated with the selected course segment.

2. The method of claim 1, wherein the step of electronically receiving the plurality of course management inputs from the teacher, includes electronically receiving at least one of a plurality of inputs selected from the group consisting of: (a) a page input to add an electronic page, (b) a content creation input to create at least part of the variable course content within the electronic page, (c) a document input to incorporate an electronic document into the electronic page, the electronic document being part of the variable course content, and (d) an instruction input to add an instruction related to at least part of the variable course content.

3. The method of claim 2, which includes: (a) electronically requesting a student feedback from the student related to the electronic document; (b) electronically displaying the student feedback to the teacher; (c) electronically receiving from the student, at least a partially completed version of the electronic document; (d) electronically providing the teacher with access to the received version of the electronic document; (e) electronically receiving a teacher feedback from the teacher related to the received version of the electronic document; and (f) electronically providing the student with access to the teacher feedback.

4. The method of claim 2, wherein electronically receiving the document input includes electronically receiving from the teacher, a downloadable homework assignment document.

5. The method of claim 3, which includes electronically receiving from the student, an upload input to enable the student to upload a completed version of the downloadable assignment document.

6. The method of claim 2, wherein the step of electronically receiving the course management inputs, includes electronically receiving a notice input from the teacher to incorporate a notice into the electronic page with respect to at least part of the variable course content.

7. A data storage device comprising:
a plurality of computer-readable instructions executable by a processor to:
(a) display a course management interface useful to manage an educational course taught by a teacher, the educational course having a sequence of course segments to provide an educational experience for a student;
(b) for each one of the course segments, receive a plurality of course management inputs during the educational course based on the educational experience, each one of the course segments being associated with variable course content;
(c) display a course session interface useful to receive the educational experience through the sequence of course segments, the course session interface including a course navigation menu, the course navigation menu indicating the sequence of course segments;
(d) receive a selection of one of the course segments; and
(e) produce a course output associated with the selected course segment, the course output including at least part of the variable course content associated with the selected course segment.

8. The data storage device of claim 7, wherein the course management inputs include at least one of a plurality of inputs selected from the group consisting of (a) a page input to add an electronic page, (b) a content creation input to create at least part of the variable course content within the electronic page, (c) a document input to incorporate an electronic document into the electronic page, the electronic document being part of the variable course content, and (d) an instruction input to add an instruction related to at least part of the variable course content.

9. The data storage device of claim 8, which includes a plurality of computer-readable instructions executable by the processor to: (a) request a student feedback from the student related to the electronic document; (b) graphically represent the student feedback response to the teacher; (c) receive from the student, at least a partially completed version of the electronic document; (d) enable the teacher to access the received version of the electronic document; (e) receive a teacher feedback from the teacher related to the received version of the electronic document; and (f) enable the student to access the teacher feedback.

10. The data storage device of claim 8, wherein the electronic document includes a downloadable homework assignment document.

11. The data storage device of claim 10, wherein the course session interface includes an upload input to enable the student to upload a completed version of the downloadable assignment document.

12. The data storage device of claim 8, wherein the course management inputs include a notice input to incorporate a notice into the electronic page with respect to at least part of the variable course content.

13. The data storage device of claim 2, wherein the course management inputs include a language change input associated with a plurality of different languages, the data storage device including at least one computer-readable instruction executable by the processor to:
(a) receive the language change input from the teacher; and
(b) translate text within the course content from one language to a different language.

14. The data storage device of claim 8, wherein the course management interface includes a plurality of software modules, including a reports software module, a partners software module, an administrators software module, an administrator profile software module, a teacher software module, a candidates software module, a content management software module, a chat communication software module and a forum software module, the data storage device including a plurality of computer-readable instructions executable by the processor to:
(a) receive inputs associated with the teacher's selection of the software modules; and
(b) manage functionality associated with the selected software modules.

15. The data storage device of claim 8, wherein the course session interface includes a course session menu, the course session menu indicating a plurality of software modules, including a timeline software module, an email software module, a student profile software module, a forum software module and a chat communication software module, the data storage device including a plurality of computer-readable instructions executable by the processor to:
(a) receive inputs associated with the student's selection of the software modules; and
(b) manage functionality associated with the selected software modules.
